(19) United States
(12) Patent Application Publication
(10) Pub. No.: US 2013/0328942 A1
(43) Pub. Date: Dec. 12, 2013

(54) HEAD UP DISPLAY FOR A VEHICLE

(71) Applicant: Stephen CHEN, Changhua (TW)

(72) Inventor: Stephen CHEN, Changhua (TW)

(21) Appl. No.: 13/494,024

(22) Filed: Jun. 12, 2012

(51) Int. Cl. G09G 5/00

(52) U.S. Cl. 345/690

(57) ABSTRACT

A head up display for a vehicle uses an anti-peep film to limit the optical image from the display module to be projected along a predetermined path, and the HUD is particularly designed so that the driver just can see the optical image displayed on the windshield without being able to see the optical image displayed on the display module. The use of the anti-peep film can reduce the brightness of the optical image projected from the display module. Therefore, a brightness-enhancement module is used to enhance the brightness of the optical image projected from the display module, so as to ensure that the optical image projected onto the reflection film from the display module can be clearly seen. Moreover, a first light source below the light guiding layer of the backlight module to substantially enhance the brightness of the optical image projected from the display module.

### BACKGROUND OF THE INVENTION

1. Field of the Invention

The present invention relates to a head up display for a vehicle, and more particularly to a head up display which is capable of enhancing the brightness of the optical image projected from the display module.

2. Description of the Prior Art

HUD (head up display) is disposed on a dashboard to project the driving information onto the windshield, so that the driver can read the driving information while driving, without looking down to see the information displayed on the dashboard, thus improving road safety.

The existing HUD usually uses a display module to project optical image onto the windshield for the driver to read. The optical image is also displayed on the outer surface the display module, and the optical image itself has brightness, which will distract the driver, and consequently affect road safety.

The present invention has arisen to mitigate and/or obviate the afore-described disadvantages.

### SUMMARY OF THE INVENTION

The primary object of the present invention is to provide a head up display for a vehicle, which is capable of improving road safety.

To achieve the above object, a head up display for a vehicle in accordance with the present invention comprises a backlight module, a brightness-enhancement module, a display module, an anti-peep film and a reflection film. The backlight module includes a light guiding layer, a first light source disposed at one end of the light guiding layer, and a reflection layer below the light guiding layer. The first light source is formed by two layers of light emitting diodes. The brightness-enhancement module is disposed on the backlight module and comprises a diffusion layer located on the top of the light guiding layer, a first polarizer disposed on the diffusion layer, a second polarizer disposed on the first polarizer, and a third polarizer disposed on the second polarizer. The display module is disposed on the brightness-enhancement module to project out an optical image. The anti-peep film is disposed on the display module and located in a projection path to limit the optical image projected from the display module to be projected along a predetermined path. The reflection film is disposed on a windshield to reflect the optical image projected from the anti-peep film.

The first light source is preferably formed of high brightness light emitting diodes. Preferably, one of the first, second and third polarizer is a dual brightness enhancement film.

Preferably, the backlight module further comprises a second light source which is located at another end of the light guiding layer opposite the first light source.

Preferably, the second light source is formed by high-brightness light emitting diodes.

Another head up display for a vehicle comprises a backlight module, a brightness-enhancement module, a display module, an anti-peep film and a reflection film. The backlight module includes a light guiding layer, a first light source disposed at both ends of the light guiding layer, and a reflection layer below the light guiding layer, the first light source is formed by a single layer of light emitting diodes. The brightness-enhancement module is disposed on the backlight module and comprises a diffusion layer located on the top of the light guiding layer, a first polarizer disposed on the diffusion layer, a second polarizer disposed on the first polarizer, and a third polarizer disposed on the second polarizer. The display module is disposed on the brightness-enhancement module to project out an optical image. The anti-peep film is disposed on the display module and located in a projection path to limit the optical image projected from the display module to be projected along a predetermined path. The reflection film is disposed on a windshield to reflect the optical image projected from the anti-peep film.

Yet, another head up display for a vehicle in accordance with the present invention comprises: a backlight module, a brightness-enhancement module, a display module, an anti-peep film, a reflection film, and a photosensitive member.

The backlight module includes a light guiding layer, a first light source disposed at one end of the light guiding layer, and a reflection layer below the light guiding layer. The first light source is formed by two layers of light emitting diodes. The brightness-enhancement module is disposed on the backlight module and comprises a diffusion layer located on the top of the light guiding layer, a first polarizer disposed on the diffusion layer, a second polarizer disposed on the first polarizer, and a third polarizer disposed on the second polarizer. The display module is disposed on the brightness-enhancement module to project out an optical image. The anti-peep film is disposed on the display module and located in a projection path to limit the optical image projected from the display module to be projected along a predetermined path. The reflection film is disposed on a windshield to reflect the optical image projected from the anti-peep film. The photosensitive member is used to detect and adjust the brightness of the optical image projected from the display module.

The photosensitive member is preferably disposed on the windshield and electrically connected to the display module.

### BRIEF DESCRIPTION OF THE DRAWINGS

FIG. 1 shows a head up display for a vehicle for a first embodiment of the present invention;

FIG. 2 shows a head up display for a vehicle for a second embodiment of the present invention;

FIG. 3 shows a head up display for a vehicle for a third embodiment of the present invention;

FIG. 4 shows a head up display for a vehicle for a fourth embodiment of the present invention; and

FIG. 5 shows a head up display for a vehicle for a fifth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

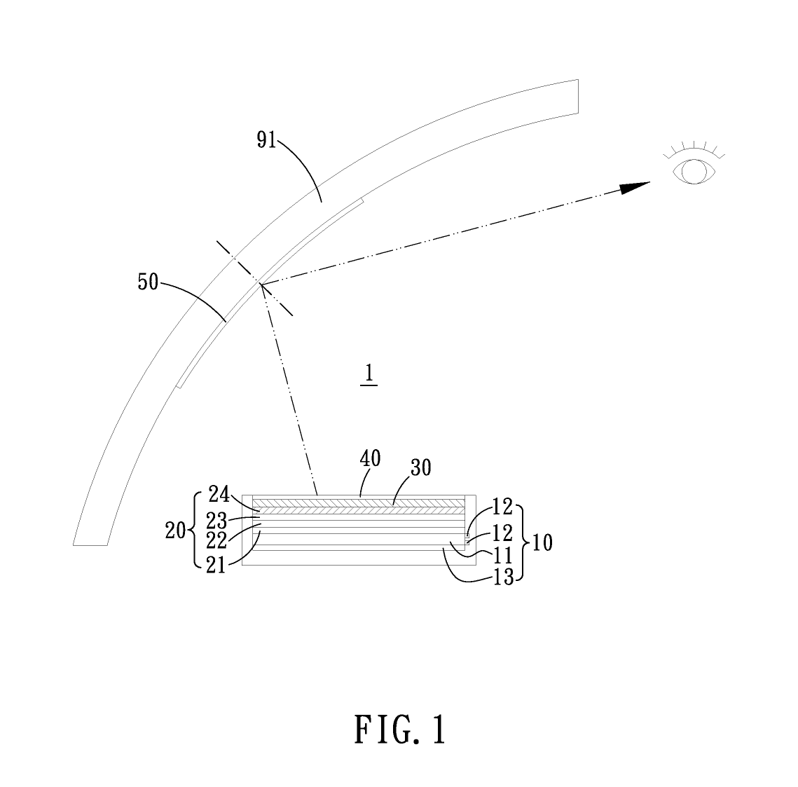

Referring to FIG. 1, a HUD (head up display) 1 for a vehicle in accordance with a firs embodiment of the present invention comprises: a backlight module 10, a brightness-enhancement module 20, a display module 30, an anti-peep film 40 and a reflection film 50.

The backlight module 10 comprises a light guiding layer 11, a first light source 12 disposed at one end of the light guiding layer 11, and a reflection layer 13 below the light guiding layer 11. In this embodiment, the first light source 12 is formed by two layers of high-brightness LED (light emitting diode).

The brightness-enhancement module 20 is disposed on the backlight module 10 and comprises a diffusion layer 21 located on the top of the light guiding layer 11, a first polarizer 22 on the top of the diffusion layer 21, a second polarizer 23 on the top of the first polarizer 22, and a third polarizer 24 disposed on the second polarizer 23. One of the first, second and third polarizers 22, 23, 24 is a dual brightness enhancement film.

The display module 30 is disposed on the brightness-enhancement module 20 to project out an optical image.

The anti-peep film 40 is disposed on the display module 30 and located in the projection path to limit the optical image from the display module 30 to be projected along a predetermined path (the projection path).

The reflection film 50 is disposed on the windshield 91 to reflect the image projected from the anti-peep film 40.

The present invention uses the anti-peep film 40 to limit the optical image from the display module 30 to be projected along a predetermined path, and the HUD is particularly designed so that the driver just can see the optical image displayed on the windshield without being able to see the optical image displayed on the display module. It is to be noted that the use of the anti-peep film 40 can reduce the brightness of the optical image projected from the display module 30. Therefore, the present invention arranges the brightness-enhancement module 20 (especially the first, second or third polarizer 22, 23, 24 which is a DBEF, dual brightness enhancement film) to enhance the brightness of the optical image projected from the display module 30, so as to ensure that the optical image projected onto the reflection film 50 from the display module 30 can be clearly seen. Moreover, the present invention also arranges the first light source 12 below the light guiding layer 11 of the backlight module 10 to substantially enhance the brightness of the optical image projected from the display module 30.

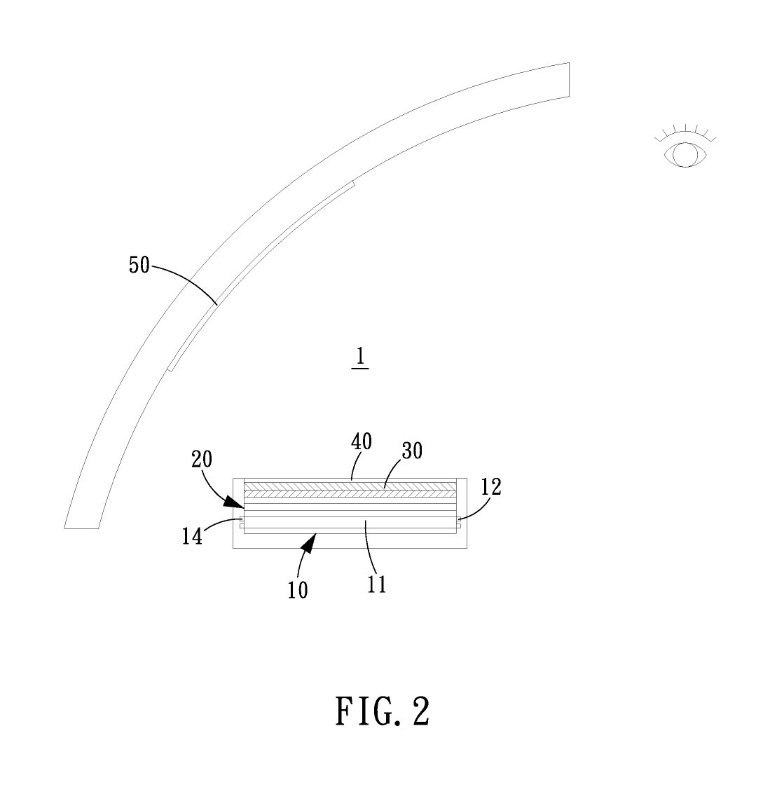

Referring to FIG. 2, a HUD 1 in accordance with a second embodiment of the present invention is similar to the previous embodiment, except that:

The backlight module 10 further comprises a second light source 14 which is located at another end of the light guiding layer 11 opposite the first light source 12. The second light source 14 is also formed by two layers of high-brightness LED (light emitting diode) to enhance the optical image projected from the display module 30.

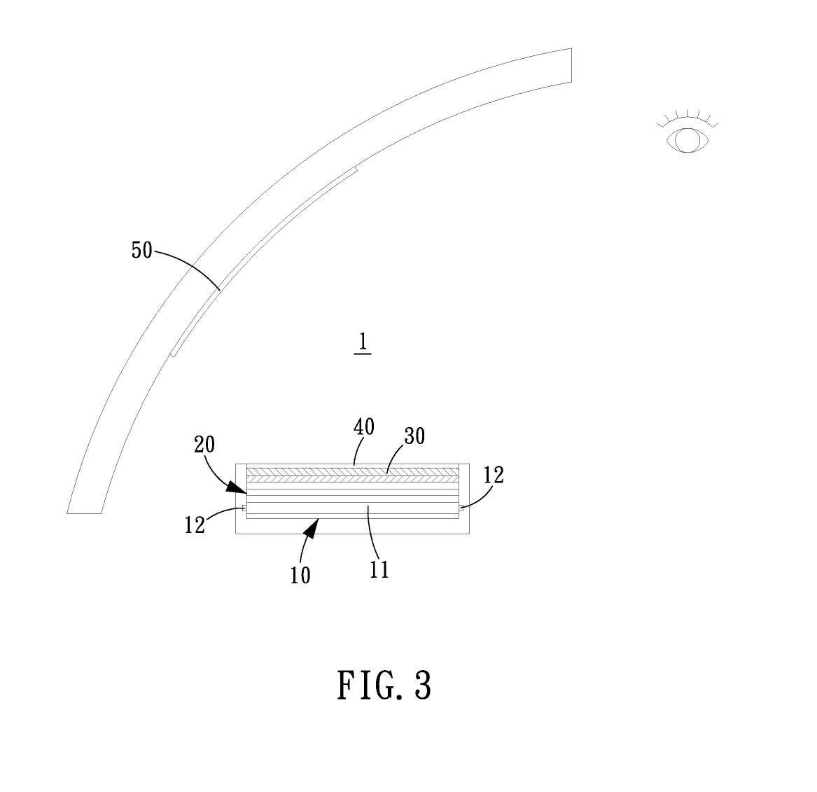

Referring to FIG. 3, a HUD 1 in accordance with a third embodiment of the present invention is similar to the first embodiment, except that:

The first light source 12 is disposed at each of two ends of the light guiding layer 11, and the first light source 12 is formed by a single layer of high-brightness LED.

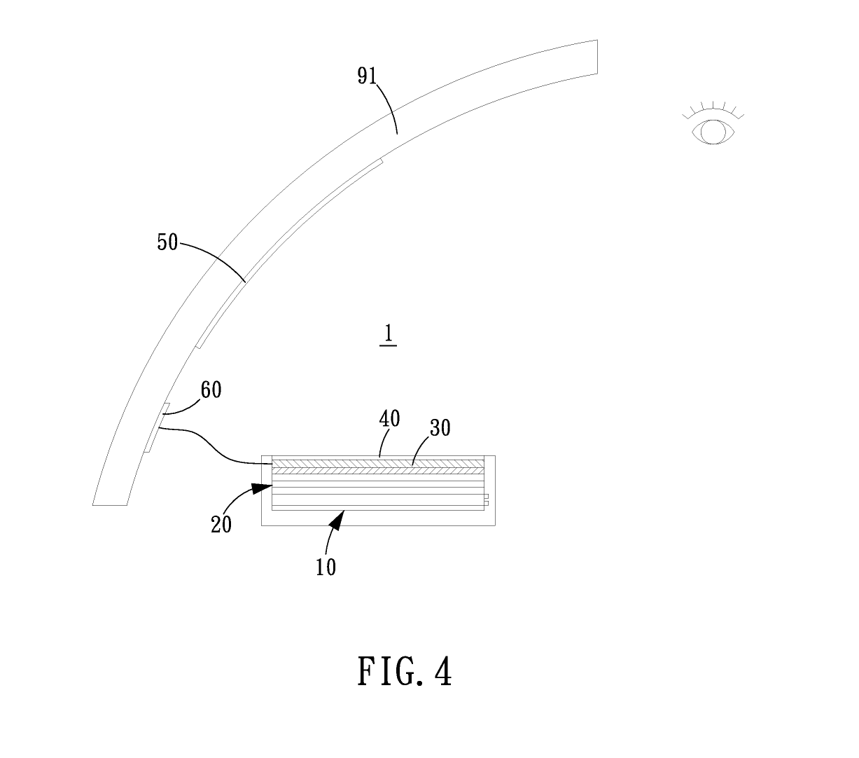

Referring to FIG. 4, a HUD 1 in accordance with a fourth embodiment of the present invention is similar to the first embodiment, except that: the HUD 1 further comprises a photosensitive member 60 which is disposed at the windshield 91 and electrically connected to the display module 30 to detect the brightness of light, so that the brightness of the optical image projected from the display module 30 can be adjusted accordingly.

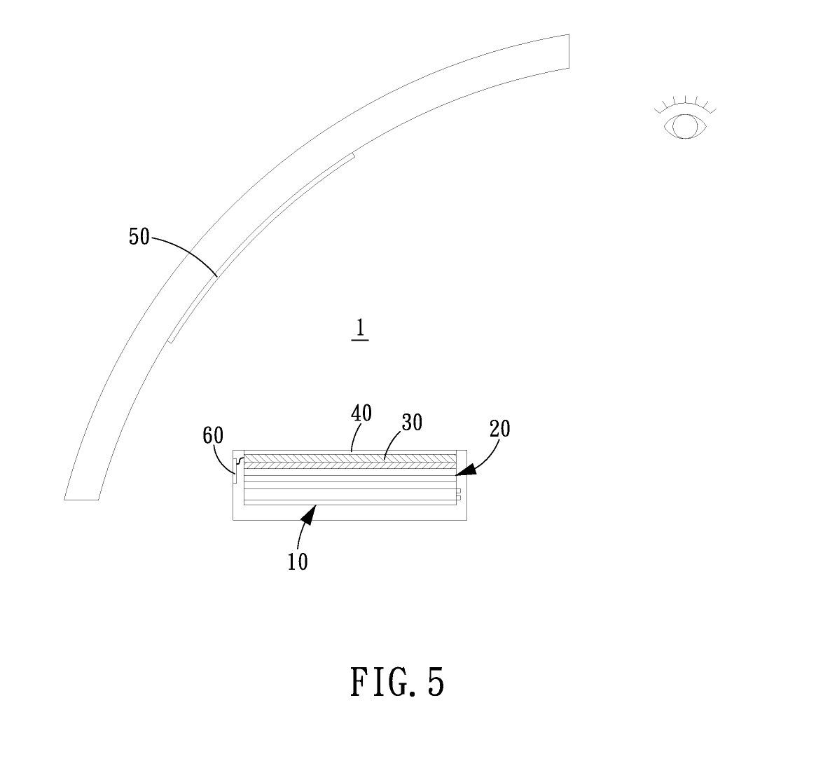

Referring to FIG. 5, a HUD 1 in accordance with a fifth embodiment of the present invention is similar to the first embodiment, except that: the HUD 1 further comprises a photosensitive member 60 which is electrically connected to the display module 30 to detect the brightness of light, so that the brightness of the optical image projected from the display module 30 can be adjusted accordingly.

While we have shown and described various embodiments in accordance with the present invention, it is clear to those skilled in the art that further embodiments may be made without departing from the scope of the present invention.

What is claimed is:

1. A head up display for a vehicle comprising:
a backlight module including a light guiding layer, a first light source disposed at one end of the light guiding layer, and a reflection layer below the light guiding layer, the first light source being formed by two layers of light emitting diodes;
a brightness-enhancement module disposed on the backlight module and comprising a diffusion layer located on the top of the light guiding layer, a first polarizer disposed on the diffusion layer, a second polarizer disposed on the first polarizer, and a third polarizer disposed on the second polarizer;
a display module disposed on the brightness-enhancement module to project out an optical image;
an anti-peep film disposed on the display module and located in a projection path to limit the optical image projected from the display module to be projected along a predetermined path; and
a reflection film disposed on a windshield to reflect the optical image projected from the anti-peep film.

2. The head up display for a vehicle as claimed in claim 1, wherein the first light source is formed of high brightness light emitting diodes.

3. The head up display for a vehicle as claimed in claim 1, wherein one of the first, second and third polarizer is a dual brightness enhancement film.

4. The head up display for a vehicle as claimed in claim 1, wherein the backlight module further comprises a second light source which is located at another end of the light guiding layer opposite the first light source.

5. The head up display for a vehicle as claimed in claim 4, wherein the second light source is formed by high-brightness light emitting diodes.

6. A head up display for a vehicle comprising:
a backlight module including a light guiding layer, a first light source disposed at both ends of the light guiding layer, and a reflection layer below the light guiding layer, the first light source being formed by a single layer of light emitting diodes;
a brightness-enhancement module disposed on the backlight module and comprising a diffusion layer located on the top of the light guiding layer, a first polarizer disposed on the diffusion layer, a second polarizer disposed on the first polarizer, and a third polarizer disposed on the second polarizer;
a display module disposed on the brightness-enhancement module to project out an optical image;
an anti-peep film disposed on the display module and located in a projection path to limit the optical image projected from the display module to be projected along a predetermined path; and
a reflection film disposed on a windshield to reflect the optical image projected from the anti-peep film.

7. The head up display for a vehicle as claimed in claim 6, wherein the first light source is formed of high brightness light emitting diodes.

8. The head up display for a vehicle as claimed in claim 6, wherein one of the first, second and third polarizer is a dual brightness enhancement film.

9. A head up display for a vehicle comprising:
a backlight module including a light guiding layer, a first light source disposed at one end of the light guiding layer, and a reflection layer below the light guiding layer, the first light source being formed by two layers of light emitting diodes;
a brightness-enhancement module disposed on the backlight module and comprising a diffusion layer located on the top of the light guiding layer, a first polarizer disposed on the diffusion layer, a second polarizer disposed on the first polarizer, and a third polarizer disposed on the second polarizer;
a display module disposed on the brightness-enhancement module to project out an optical image;
an anti-peep film disposed on the display module and located in a projection path to limit the optical image projected from the display module to be projected along a predetermined path;
a reflection film disposed on a windshield to reflect the optical image projected from the anti-peep film; and
a photosensitive member for detecting and adjusting brightness of the optical image projected from the display module.

10. The head up display for a vehicle as claimed in claim 9, wherein the first light source is formed of high brightness light emitting diodes.

11. The head up display for a vehicle as claimed in claim 9, wherein one of the first, second and third polarizer is a dual brightness enhancement film.

12. The head up display for a vehicle as claimed in claim 9, wherein the photosensitive member is disposed on the windshield and electrically connected to the display module.

13. The head up display for a vehicle as claimed in claim 9, wherein the photosensitive member is electrically connected to the display module.
